(19) United States
(12) Patent Application Publication
(10) Pub. No.: US 2019/0279578 A1
(43) Pub. Date: Sep. 12, 2019

(54) RETAIL SYSTEM FOR IDENTIFYING AND LOCATING PRODUCTS AND ELECTRONIC DISPLAYS, AND PROVIDING ENVIRONMENTAL INDEX INFORMATION FOR DISPLAY NEAR RELEVANT PRODUCTS

(71) Applicant: Shelfbucks, Inc., Austin, TX (US)

(72) Inventor: Gary L. Overhultz, Oak Park, IL (US)

(21) Appl. No.: 16/294,443

(22) Filed: Mar. 6, 2019

Related U.S. Application Data
(60) Provisional application No. 62/639,721, filed on Mar. 7, 2018.

(51) Int. Cl. G09G 3/34; H04L 12/66; H04W 4/021; H04W 4/23; H04W 4/80

(52) U.S. Cl. CPC G09G 3/344; H04L 12/66; H04W 4/021; G09G 2380/06; H04W 4/80; G09G 2380/04; H04W 4/23

(57) ABSTRACT

A method for providing environmental index information for display near relevant products in a retail environment includes: receiving index information at a gateway, selectively awakening an index controller with a unique ID based on an indicator of its proximity to a related product or product display; communicating index information to the index controller when the index controller is on or in the vicinity of a product or product shelf that is associated with the index information; and displaying the index information on an electronic display. A system for implementing the method at least in part wirelessly and automatically is also provided.

### CROSS-REFERENCE TO RELATED APPLICANTS

This application claims the benefit of priority to U.S. provisional application 62/639,721 filed on Mar. 7, 2018. This prior application is incorporated by reference herein for all purposes.

### FIELD

The technology described herein relates generally to the fields of wireless identification systems and product displays. More particularly, systems and methods are described for identifying a display, and coordinating and communicating with a product display.

### BACKGROUND AND SUMMARY

Product manufacturers and retailers occasionally utilize electronic media displays (e.g., electronic signs, audio broadcasting systems, video broadcasting systems, etc.) to promote product sales in stores and other retail environments. The degree to which advertising impacts product sales is often gated by the execution, timing, and location of appropriate product displays. Ensuring that the products are located in close proximity with the media displays and coordinating the timing and content of the messaging will typically yield the greatest sales gain. In many cases, retailers desire to collect payment for the use of retail space both for products and media display space. There is a need for a cost-effective way to link the displayed message appropriately with the product display, particularly if this can be done remotely from the facility.

While online purchasing is becoming more and more popular, brick and mortar stores continue to have some features that are advantageous. Providing information to the consumer to leverage the geographic location of the brick and mortar store more effectively can accentuate the special geographic relevance of the traditional store to the consumer.

In addition, it would be desirable to be able to convey relevant and timely information that is of interest to a consumer in making a purchasing decision about a particular product on a display at or near a relevant product display. For example, daily environmental index information is especially relevant to certain health products and could serve to inform and induce a consumer's purchasing decision.

In an embodiment, a system comprises: a gateway capable of transmitting and receiving index information in communication with a server; an index controller with a unique ID configured to wirelessly receive the index information from the gateway; and an electronic display coupled to the index controller. The index controller and electronic display is on or in the vicinity of a product or product display unit in a retail environment, the electronic display displaying the index information, and the index information is associated with a geographical location of the retail environment. The system also includes a storage device stores the index controller's unique ID associated with the product, the index information related to the product, and the geographical location of the index controller or the gateway that is in communication with the index controller. The system also includes a processor that executes instructions configured to determine whether the index controller is on or in the vicinity of the product or product display unit.

In an embodiment, a system includes: a gateway capable of transmitting and receiving index information in communication with a server; an index controller with a unique ID configured to wirelessly receive the index information from the gateway; and an index controller coupled to an electronic display. The index controller and electronic display are in the vicinity of a product or product display unit in a retail environment that is associated with the index information, and the index information is displayed on the electronic display. Whether the index controller is on or in the vicinity of the product or product display unit is determined by a wireless identification tag on the index controller and a wireless identification tag on the product or product display unit.

In an embodiment, a method for providing environmental index information for display near relevant products in a retail environment includes the steps of : receiving index information at a gateway; selectively awakening an index controller with an ID by a wireless signal based on a wireless identification tag on the index controller and optionally its proximity to a product or product display unit with a wireless identification tag; communicating index information to the index controller when the index controller is on or in the vicinity of a product or product shelf that is associated with the index information; and displaying the index information on an electronic display.

### BRIEF DESCRIPTION OF THE DRAWINGS

FIG. 1 is a schematic diagram of an exemplary system.

FIG. 2 is a front perspective view of an embodiment of an index controller and display.

FIG. 3 is a rear perspective view of an embodiment of an index controller and display.

FIG. 4 is a perspective view of a product and a product display unit.

FIG. 5 is a perspective view of an e-paper display.

FIG. 6 is a flow chart showing an exemplary process for providing environmental index information in a retail store.

FIG. 7 is a schematic diagram that depicts an example retail advertising system for coordinating an advertising message with a product display.

FIG. 8 is a schematic diagram depicting an example retail advertising system that includes a remotely located advertisement coordination system.

FIGS. 9 and 10 depict are schematic diagrams showing an example retail advertising system in which broadcast advertising messages are dynamically controlled based on information obtained from a wireless identification system.

FIG. 11 depicts a schematic diagram showing an example method for coordinating an advertising message with a product display.

FIG. 12 depicts a schematic diagram showing an example RF system that covers a designated area such as an entire retail facility.

FIG. 13 depicts a schematic diagram of an object having an RF tag associated therewith.

### DETAILED DESCRIPTION

Disclosed herein is a detachable and reuseable media device that can be detachably clipped onto retail displays and a system that can bring interesting information relevant to a product in the store that changes periodically, such as daily. Optionally, it can be combined in the context of a promotional offer that consumers can be notified about and take advantage of in the store. The system disclosed herein includes one or more (at least) of two synergistically prevalent features: 1) a flexible and reliable in-store infrastructure for tracking the presence of specific products; and 2) an inexpensive, flexible, and reliable way of delivering a message that has content that can be changed periodically in the vicinity of the product. The technology described herein may be useful in the systems disclosed in commonly owned U.S. Pat. Nos. 6,837,427, 6,951,305, 7,021,535, 7,614,556, and 8,408,457, the subject matter of which are incorporated herein by reference.

In an example, information is transmitted through the media device that is of interest to consumers when making purchasing decisions on products in a particular retail environment. A retail environment may be a particular store location. The index information is geographical location dependent and, for example, may include index information, such as an allergy index (or forecast) that is available for a given geography surrounding the location of the retail store, e.g., within 5 miles of the store. The information may also include the particular location, such as city and state or zipcode, to communicate the location relevance to the consumer. A current date may also be included to demonstrate the timeliness of the information. For example, the index information may indicate “Today's allergy index is very high” and may be placed in the vicinity of or actually on an allergy relief product. Such a system could be helpful to consumers, the particular brand in the vicinity (e.g., within sight, such as within 1, 3 or 10 feet in any direction) of the display and can also be advantageous to the retailer to promote more sales.

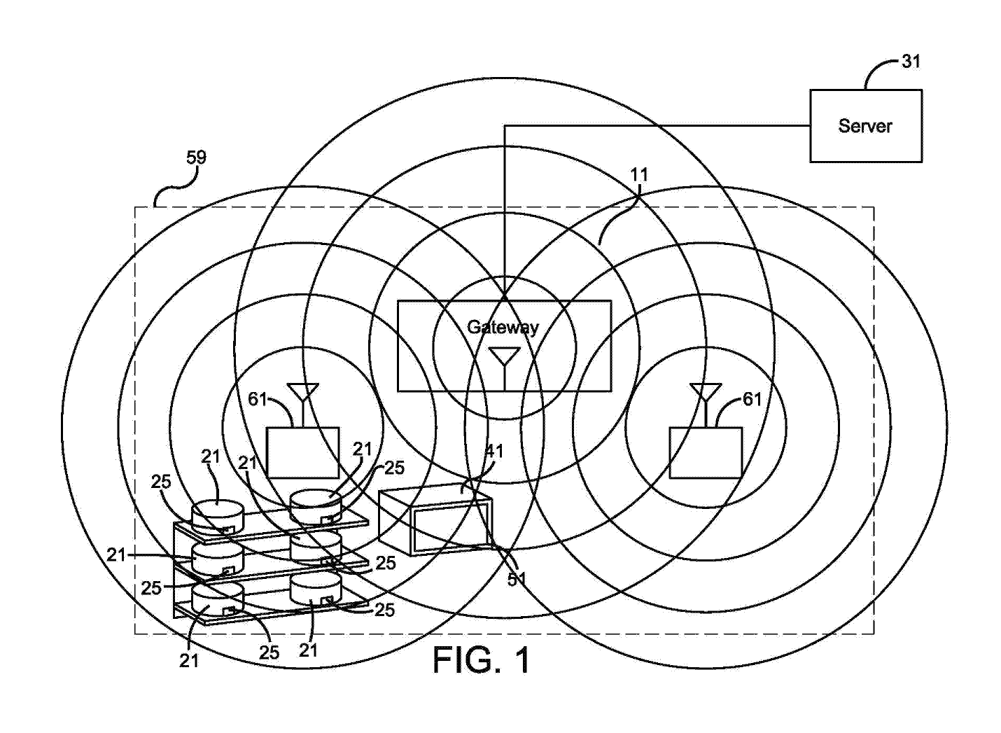

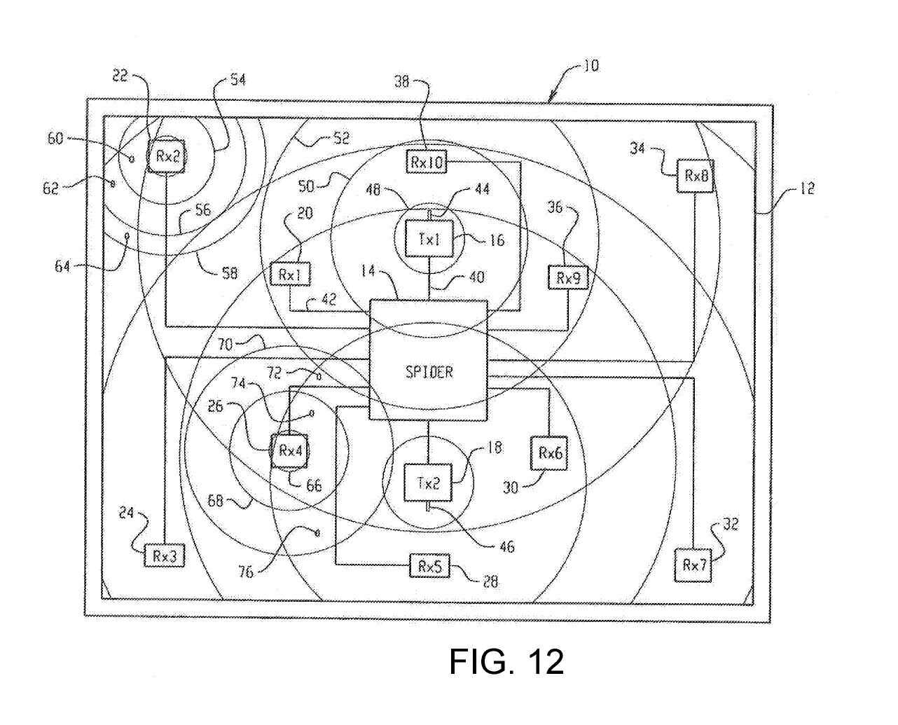

In an embodiment shown in FIG. 1, a retail environment 5, e.g., a store bounded by its walls and the surrounding area, such as within 10 to 25 feet outside the walls of the store is depicted in an overhead schematic view. (In another embodiment, the retail environment 5 could be a section or department to a store.) The system has a communication gateway 11 that collects, stores, and forwards information to a remote server throughout the store and throughout the day about the presence and location of products 21 that include a wireless identification tag 25 with a unique ID, e.g., an RF-tag. This information is forwarded to a remote server 31, located outside retail environment 5. Optionally, a repeater 61 can be used to extend the range of the gateway's wireless communications through the retail environment 5, and optionally, the remote server 31 could be located within the retail environment 5. A system such as that disclosed in FIG. 12 can be used to cover a large area or the entire area of a retail establishment.

In an embodiment, the server 31 can be located on a product manufacturer's property that has products in the retail environment 5 and controlled by the product manufacturer. The server 31 translates and integrates the wireless identification tag's 25 ID into attributes about the store, the product, the marketing plan, and the sales associated with the product 21. The gateway 11 in a store can be used to identify to the server 31 which RF tags 25 are present in the store at any point in time. The server 31 can be used to identify which tags 25 are enlisted to convey specific information about a product 21, including the approximate location of the tag 25 and whether the content (index information) is being displayed. As the server 31 encounters updated information about an index, that new index information can be relayed to the gateway 11, and from the gateway 11 to the tag 25 displaying the relevant information to consumers. Further, when the server 31 detects that the tag 25 has been removed and/or relocated to a different area, such as a storage area in the store, the server 31 can automatically, without further user input suspend further index information transmission or display until the tag 25 is redeployed on a display in the retail environment 5. The server 31 can also identify sales from the store's POS system to examine the value of the display, and the timing of its presence and location in the retail environment compared with a prescribed marketing plan. In an embodiment, the product manufacturer can thus be informed about the location of the unsold product 21 in the retail environment 5, shelf stock, and sales information.

In an embodiment of the system disclosed herein, the server 31 forwards daily index information to gateway 11 associated with a particular retail environment 5. The index information is specific to the region in which the retail environment 5 is located, such as, for example, a current allergy index, flu index, pollution index, wind-chill factor, heat index, humidity rating, sunburn index, temperature, or mosquito count, all of which could be of interest to consumers when making purchasing decisions on products in the particular retail environment 6. Generally, this type of information can be described as environmental information.

In an embodiment, the index information for multiple products in the retail environment 5 is transmitted in a single index information packet to the gateway 11. The gateway 11, processes this index packet information and transmits signals to index controllers 41 with electronic displays 51 on or near product displays or products 21. The index controller 41 may include a processor, a storage device, a receiver, and a transmitter. The index controller 41 receives and processes the index packet information from the gateway 11 and communicates with the electronic display 51, controlling what is displayed.

In an embodiment, the gateway 11 or a server on the retail environment 5 premises may include a GPS system, and the GPS coordinates can be used to transmit a location of the retail environment 5 to the remote server 31, where index information can be matched to the GPS location of the retail environment 5, and matched to the index controller 41 that is in the vicinity of the relevant product 21 for the index information. In another embodiment, the geographical location of the index controllers 41 or the gateway 11 in the retail environment 5, may be statically set to the location of the intended retail environment 5.

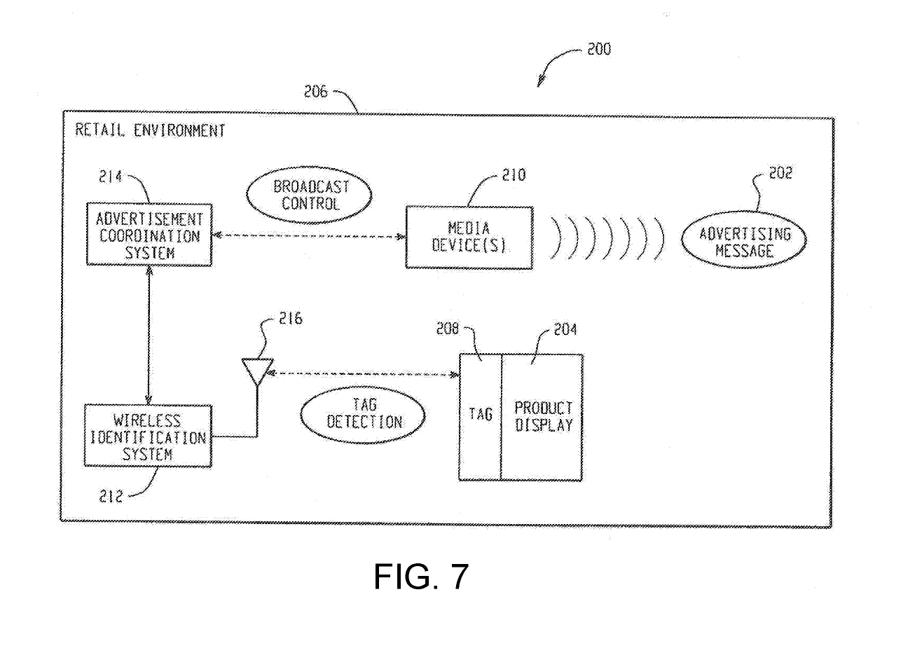

In addition, the gateway 11, server 31, and wireless identification tag 25 may have further functionality including that described in FIGS. 7-13 and accompanying text. In particular, the server 31 stores information from the store about the wireless identification tags 25 present in the store, as well as information to be passed to the gateway 11 in the store regarding the current status of specific indexes.

The gateway 11 in each store is capable of receiving information from the server 31 and wirelessly transmitting it throughout the retail environment 5, and the gateway 11 is also capable of receiving information from the wireless identification tags 25 associated with products 21 or product displays throughout the retail environment 5, as well as ID tags 43 on the housing 53 or associated with the index controller 41 and/or display 51.

The wireless identification tag 25 has a unique ID that is associated with a specific product 21. The wireless identification tag 25 may be, e.g., an RF tag affixed to product before it reaches the retail environment 5, e.g., by the manufacturer or wholesaler.

The index controller 41 may have a transmission and receiving component capable of wireless transmitting and receiving, e.g., by radio-frequency or infrared wavelengths. The index controller 41 is designed to be portable and optionally interchangeable with various shelving units or displays or on products themselves. (The index controller 41 may also be integrated with the electronic display 51 in a common housing 53.) As shown in FIG. 3, the housing 53 for the index controller 41 may have a spring-loaded clip 71 on a back side opposite the display 51 or to the side of the display or some other attachment mechanism. The index controller 41 has an interface 55 for interfacing with the electronic display 51. As also shown in FIG. 3 the index controller 41 may also have conductive contacts 75 on the housing 53, such as on a clip-on area 81 of the housing 53. These contacts 75 are configured to connect with contacts on a corresponding clip-on area 83 of a product display unit 91. A product display unit 91, may be a shelf, a free-standing mobile display unit with a shelf or hanger, or other product holder. The clip-on area 83, may be, for example, a ridge on the product display unit 91. In one embodiment, the index controller 41 and the identification tag 43 are in a single enclosure.

In an embodiment, the system is used to locate a designated product 21 in the retail environment 5 and detect the simultaneous presence of an index controller 41 with an electronic display 51 in the vicinity of the designated product 21. If the simultaneous presence of the index controller 41/electronic display 51 and the designated product 21 is detected by the gateway 11 through the product ID tag 25 and the ID tag 43 coupled to the index controller 41, the index controller 41 determines that index information is displayed on the electronic display 51. The system can be used to locate various items with wireless tags, such as active, passive, or semi-passive RF tags by various methods disclosed herein, such as system and methods shown in FIGS. 7-13 and described in the text below, wherein the media device mentioned below can be the index controller 41/display 51 units disclosed above.

The index controller 41, electronic display 51, and housing 53 can be easily transportable from one piece of merchandising material to another. In an embodiment, the index controller 41 has electrical contacts 75 to couple with electronic contacts 85 on the mechanism where it attaches to the product display unit 91. (See FIG. 4.) If desired, battery or AC power can be provided through the contacts 85 on the product display unit 91 with a power source located on the product display unit 91 or wired to AC power through the display unit. By making this electronic contact, an indication signal, such as a matching signature signal detected by the index controller 41, can be provided that the index controller 41 has been moved and attached in the right location on new merchandising material as well as to indicate the specific merchandising campaign that material is associated with. For example, the electrical contact 85 on new merchandising material can convey to the index controller 41 an identification string that allows the controller 41 to then register with the gateway 11 that it has been recently attached to new merchandising material containing different products. The gateway 11 can then send the updated ID to the remote server 31 to pair the controller 41 with new index information, which can be periodically updated and downloaded as required for the specific marketing plan for the products contained on the new merchandising material. This also serves as an alternative to using RF tags 43 to confirm that the controller 41 and display 51 are in the same vicinity as the products 21. The index controller 41 can transmit information indicating a correct match back to the gateway 11 and server 31 to confirm that it is displaying relevant and timely information at any given time across any number of targeted merchandising materials that the index controller 41 or controllers 41 are associated with.

When a particular marketing program concludes, the index controller 41 and electronic display 51 could either be stored for later use or transferred to a new piece of merchandising material (or the shelf or vicinity thereof). A reset button on the housing 53 could be pressed to indicate that the device has been transferred, information about the new material that it is now affixed to could be transmitted, and a new message for display could be received from the gateway 11.

FIG. 5 shows an example electronic (e-paper) display 51 with contacts 57 for interfacing with an index controller 41. In an embodiment, the index controller 41 is coupled to an e-paper display 51 to convey the index information to consumers. Some versions of e-paper (such as bistable electrophoretic displays from PlasticLogic) only require power when the information content is changing, and would, therefore, allow a small battery to provide the updated information over the course of several years before needing to be replaced, even when the display is updated daily. The e-paper display 51 remains in rest state until the gateway 11 sends a signal specific to the ID associated with the index controller 41 for the e-paper display 51.

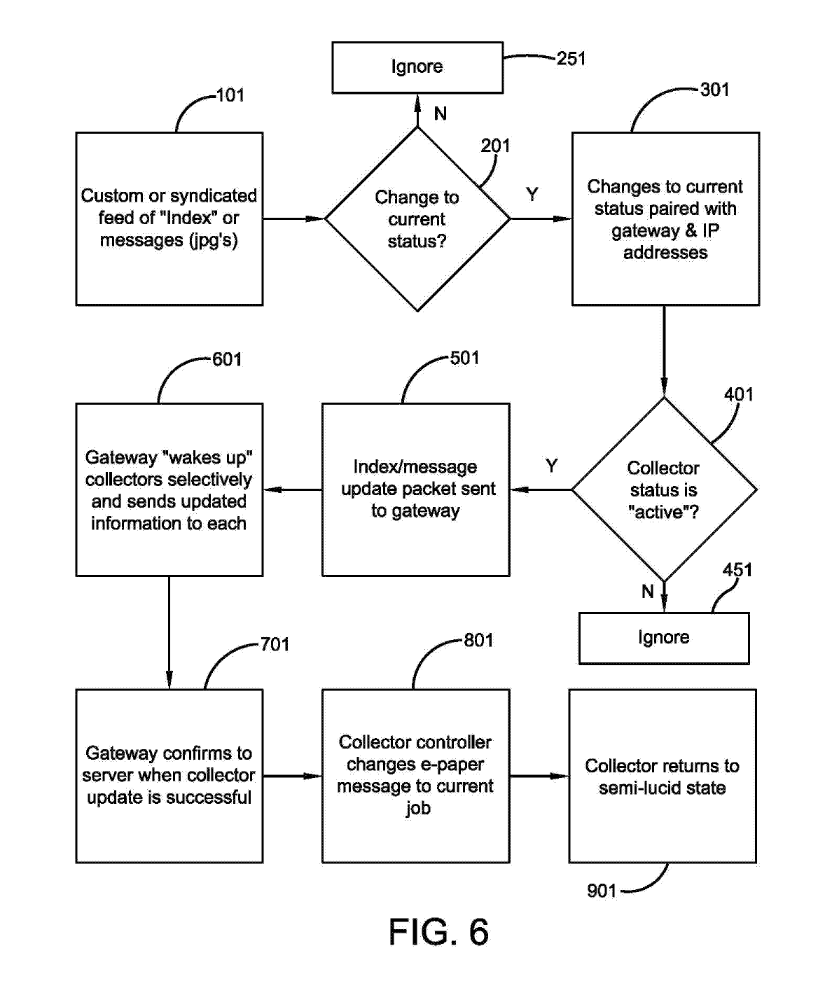

A flow chart for an exemplary method of providing daily or periodic information relevant to products in a retail environment in the vicinity of the product is shown in FIG. 6. At step 101 a custom or syndicated feed of an environmental index (e.g., stored on a server) is communicated. In an embodiment, a processor on the gateway in the retail environment receives (e.g., through the Internet or cellular network) and communicates the feed. In an embodiment, a processor on a remote server receives (e.g., through the Internet or cellular network) and communicates the feed. Other messages for display could be communicated as well or instead of the index information. For example, the information can be in the form of a jpg gif or other media file. The information can be associated with specific products when communicated to the gateway in the store.

At 201, a decision is made as to whether a change to the current status is required. If no change is required, then the communication can be ignored 251. This can be based on whether a particular index has changed since the prior day. For example, if the tree pollen forecast for the day is high and was also high yesterday, no change may be necessary. In an embodiment, the index message may not change, but a date may change on the message. In an embodiment, a processor on the gateway in the retail environment makes this determination based on a feed from the Internet or cellular network. In an embodiment, a processor on a remote server makes this determination. Alternatively, other components in the system could make the determination to change or not change the message, but if this is done centrally without waking up the index controller it may be advantageous for power saving purposes.

At 301 changes to current status relating to the index information or message is paired with a gateway in a retail environment or a group of gateways in a particular region. This may be done by designating an IP address of the gateway. This step may be done by a processor at the remote server or at the gateway in the retail environment.

At 401 a determination is made whether the index controller is active. Active vs. inactive service status can be determined based on whether the index information indicates a product identifier that is associated with the relevant index information for an index controller associated with the product identifier. Alternatively, this can be determined based upon whether the product is confirmed to be located in the same vicinity as the index controller. If the index controller is not active, then the index information is ignored 451.

At 501 the index information or other message is communicated to the gateway, such as from the server over the Internet or cellular network. In an embodiment, the index controller is in a rest state 98% of the time or more, e.g., 99% to 99.99% of the time. As such, the index information or other message is only transmitted to it when it is awakened and in communication with the gateway.

At 601 the index controllers are awakened selectively, e.g., by the gateway, based on whether the index information or message is relevant to the index controller and the particular product it is associated with. This can be done by sending an RF signal to provide minimal power through an RF chip to cause the index controller to turn on its battery power.

At 701 a confirmation or failure report is communicated to the server, e.g., by the gateway, after the index controller update is performed.

At 801 the index controller causes the electronic display it is associated with to change its display to display the index information or message. This change in the state of the display, such as an electronic paper display, draws on battery power.

At 901 the index controller returns to a dormant (semi-lucid) state. If the electronic display is an electrophoretic electronic paper display or similar, it can also be in a dormant state, drawing no battery power, while still showing a monochrome or black and white display.

The systems or selected components described below can be used in conjunction with the system or components described above. In some cases, the detailed description below provides additional detail of components used in the above disclosure. The controller 41, display 51, and other components in the housing 53, can be, for example, a media device described below, and various features disclosed above can be employed with various features of the system and methods described below.

FIG. 7 is a schematic block diagram that depicts an example retail advertising system 200 for coordinating an advertising message 202 with a product display 204. The product display 204 is associated with one or more products on sale in a retail environment 206, and includes an associated wireless identification tag 208. The wireless identification tag 208 may be a radio frequency identification (RF) tag that is physically attached to, or otherwise associated with, the product display 204. One or more media devices 210 are used to broadcast the advertising message 202, which relates to the one or more products associated with the product display 204. The media device(s) 210 may, for example, include an audio device (e.g., an in-store audio broadcasting system), a visual device (e.g., a digital sign or streaming banner), and/or an audio-visual device (e.g., a video monitor having audio capabilities).

The retail advertising system 200 of FIG. 7 also includes a wireless identification system 212 and an advertisement coordination system 214. The wireless identification system 212 includes at least one antenna 216 in the retail environment 206, and is configured to detect the wireless identification tag 208. The advertisement coordination system 214 determines from the wireless identification system 212 that the product display 204 is located in the retail environment 206, and in response causes the advertising media device 210 to broadcast the advertising message 202 relating to the product display 204. It should be understood that the advertisement coordination system 214 may operate completely automatically, may operate with human input, or may include a combination of automatic and human-assisted operations.

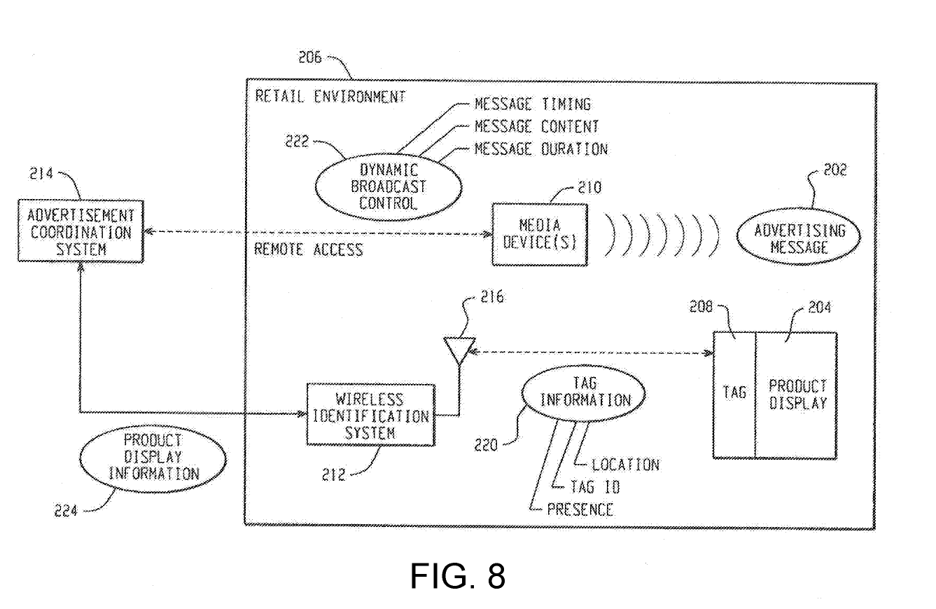

The wireless identification system 212 may be an RF system, such as the RF system described herein with reference to FIG. 12. The advertisement coordination system 214 may include one or more computers operating separately from the wireless identification system 212, or may be implemented, in whole or in part, using the resources of the wireless identification system 212. As illustrated in FIG. 8, at least a portion of the advertisement coordination system 214 may be located remotely from the retail environment 206 in certain embodiments. Similarly, the wireless identification system 212 may include components that are remotely located from the retail environment 206.

FIG. 8 also illustrates several example types of information 220 relating to the wireless identification tag 208 that may be determined by the wireless identification system 212 and several example ways in which the media device(s) 210 may be dynamically controlled 222 based on the tag information 220. For instance, the wireless identification system 212 may be configured to determine that the tag 208 is present within the retail environment 206, to identify an identification number associated with the tag 208, and/or to determine a location of the tag 208 within the retail environment 206. It should be understood that the wireless identification tag 208 could also be configured to convey additional types of information to the wireless identification system 212.

Based on the tag information 220, the advertisement coordination system 214 may be configured to control the time at which the advertising message 202 is broadcast, the content of the advertising message 202, the message duration, and/or other aspects of the advertising message 202. FIG. 8 also illustrates that the wireless identification system 212 may be used to translate the tag information 220 into information 224 relating to the product display 204 for use by the advertisement coordination system 214. For example, the wireless identification system 212 may include recorded data to associate a detected tag number with a particular product display 204 that is associated with the wireless identification tag 208.

In one example, the wireless identification system 212 may be configured to determine a location of the wireless identification tag in the retail environment. The advertisement coordination system 214 may then determine from the wireless identification system 212 that the product display 204 is located at a predetermined location within the retail environment 206, and in response cause the advertising media device(s) 210 to broadcast an advertising message 202 related to the product display 204. That is, the advertisement coordination system 214 may cause the advertising message 202 to be broadcast only when the appropriate product display 204 is installed in the appropriate location. In addition, the advertisement coordination system 214 may cause the advertising message to be broadcast at a predetermined time and/or for a predetermined duration. For instance, an advertising message 202 may be broadcast for a predetermined duration provided that the associated product display 204 is determined to be at the proper location in the retail environment at the appropriate time.

It should be understood that the term “broadcast,” as used herein, may include any means for transmitting information from an electronic medium to a human audience. It should also be understood that the terms “display” or “product display,” as used herein, are intended to cover shelves or product containers of all types, whether permanent or temporary, and may include displays, advertising or merchandising material containing products, products with other products associated with them, dump bins, signs, racks, pegboards, counter-tops, dispensers, or other materials intended to hold consumer products in a retail facility. The term “retail environment,” as used herein, may include any environment where displays and products for sale to consumers are to be used concurrently.

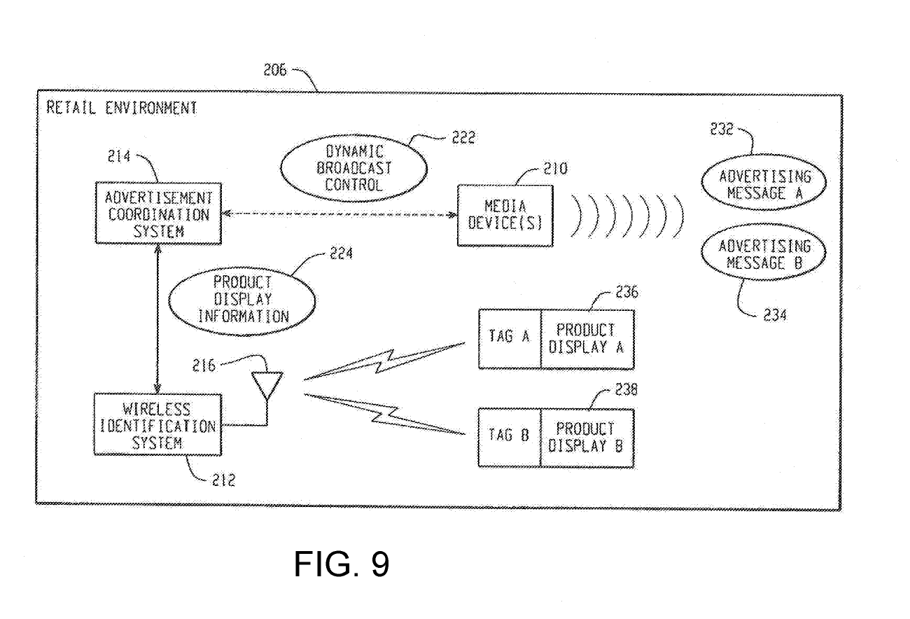

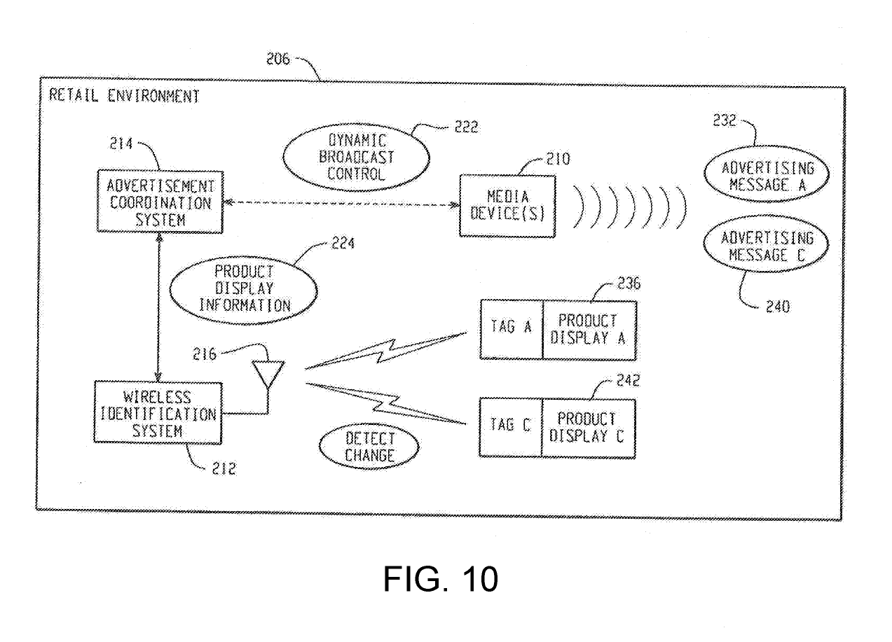

FIGS. 9 and 10 depict another example retail advertising system in which a plurality of advertising messages are dynamically controlled based upon a detected change in the product displays within the retail environment 206. As illustrated, the advertisement coordination system 214 may be configured to cause a plurality of advertising messages 232, 234 to be broadcast, either simultaneously or consecutively, in response to associated product displays 236, 238 that are detected in the retail environment 206 by the wireless identification system 212. In one example, a single advertising message (not illustrated) could be broadcast that relates to two or more product displays detected in the retail environment. For instance, a cross-merchandising promotion may be broadcast if displays relating to both of the relevant products are detected.

As shown in FIG. 10, if the wireless identification system 212 detects a change in the product displays, then the advertisement coordination system 214 may respond by dynamically changing the broadcast advertising messages accordingly. For instance, in the illustrated embodiment, Product Display B 238 is replaced with Product Display C 242, and in response the advertisement coordination system 214 stops broadcasting the message 234 associated with Product Display B 238 and begins broadcasting a message 244 associated with Product Display C 242. It should be understood, however, that the advertisement coordination system 214 could also be configured to respond to other changes in the product displays. For instance, the advertisement coordination system 214 could respond to the addition or removal of a display, the change in location of a display, the depletion of products associated with the display, and/or other changes.

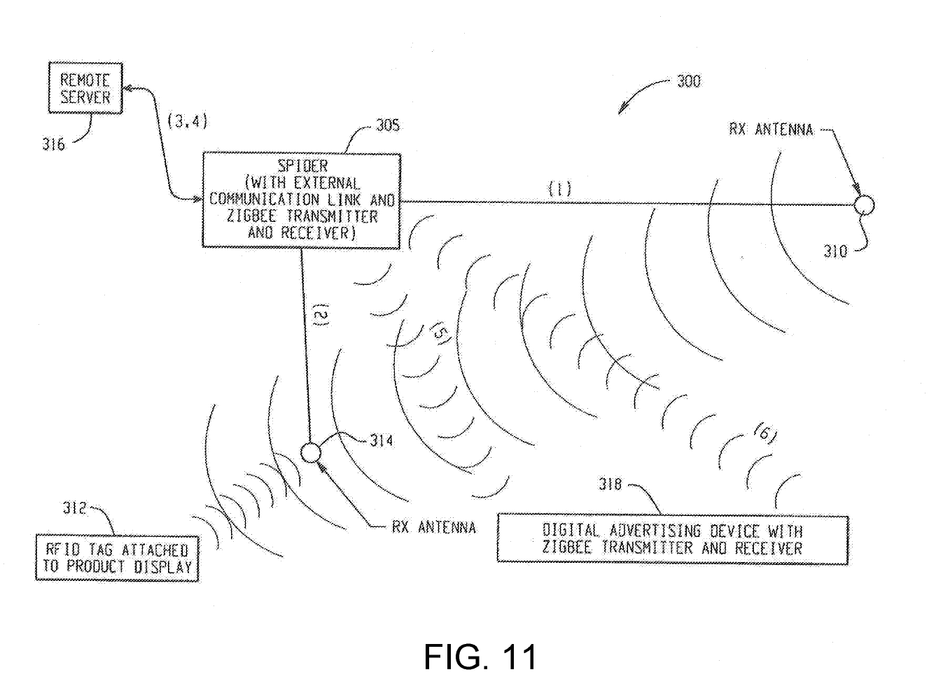

FIG. 11 is a diagram depicting an example method 300 for coordinating an advertising message with a product display. This method 300 may, for example, be implemented using the RF system described herein with reference to FIG. 12. It should be understood, however, that the method could also be implemented using other wireless identification systems. In various embodiments discussed herein the advertising messages may be replaced with the index information.

In step 1, a signal is transmitted from a transmitter 310 in the RF system 305. The signal is received by an RF tag 312 associated with a product display, and in response an RF signal from the tag 312 is transmitted to a receiver 314 in the RF system 305 in step 2. The RF signal includes information relating to the tag 312, such as a tag number, that is used by the RF system 305 to identify the associated product display. In certain embodiments, the RF signal may also be used to determine or approximate a location of the RF tag 312 within the retail environment.

In step 3, information relating to the RF tag 312 and/or its associated product display is transmitted to an advertisement coordination system 316, which may, for example, be located on a remote server. In an embodiment, the advertisement coordination system 316 may be used instead to coordinate the environmental index information for the method and system discussed above. In response to the information from the RF system 305, the advertisement coordination system 316 transmits advertising control information back to the RF system 305 in step 4. In step 5, the RF system 305 transmits the advertising control information to an advertising media device 318, which causes the media device 318 to broadcast an advertising message relating to one or more products associated with the product display. An acknowledgement signal may then be transmitted from the media device 318 to the RF system 305 in step 6 to indicate that the advertising control information has been received. The RF system 305 may communicate with the advertising device 318 using a ZigBee transmitter/receiver combination, however, other communication methods may also be used.

Using one or more embodiments of the retail advertising systems and methods described herein, one or more advertising media devices may be integrated into the location tracking network provided by an RF system, which provides timing and/or proximate location information for product displays located in a retail environment. In this manner, the RF system may be used to produce reports and/or alerts that indicate if the product displays are in an appropriate location in the retail environment at an appropriate time for broadcasting a related advertisement. In addition, the RF system may generate remediation alerts to stores that are not in compliance with an advertising agreement.

In certain embodiments, the retail advertising system may provide a dynamic play list of advertising messages for multiple advertising media devices. As an example, if multiple advertising displays are located in a particular location in a retail environment and associated advertising messages are broadcast from a particular set of media devices, the RF system may track how many times the advertising messages are broadcast when the advertising display is located in a specific area. If one of the displays is removed and replaced with a different display, then the advertising messages may be automatically changed to reflect the new display and any associated promotion. In the case of environmental index information, the system may be used to send environmental index information associated with a particular product, e.g. allergy index information when the controller is in the vicinity of an allergy medication product, and a heat or UV index information when the controller is in the vicinity of a sunscreen product.

In another example, the retail advertising system may be used to trigger the advertising or environmental index message displayed on a digital sign when multiple advertising conditions are detected. For example, an advertising message or environmental index may be broadcast when the presence of both an advertising display for a first product and an advertising display for a second, cross-merchandised product is detected.

The retail advertising systems and methods described herein may also provide an audit trail detailing how long and in what location an advertising display is in a retail environment. In this manner, product sales may be optimized using information relating to different combinations of display locations and advertising message content and frequency. In certain embodiments, the system may also be used to facilitate payment for the broadcast of advertising messages in conjunction with a product display.

In one embodiment, run times and durations for a plurality of advertising messages may be stored in a remote server associated with an RF system. The remote server may be used to link these advertising records with tag read records for associated product displays to determine the number of times, or the percentage of time, that the advertising messages are broadcast in conjunction with other in-store merchandising material. Alternatively, an advertising media device may be equipped with a transmitter, and a particular advertising message may be associated with a particular signal from the advertising media device to enable the time and duration of advertisements to be reported to the remote server by the RF system for comparison to a planned or expected playlist.

In certain embodiments, remediation reports may be generated and sent to the store or to an external remediation resource when a given product display is not present during a targeted media period. Additionally, the amount of time required to remedy an out-of-compliance condition may be tracked and reported by associating an RF tag with the targeted product display.

Additional functionality may be gained in certain embodiments by equipping an RF system with a transmitter device, such as a ZigBee transmitter, and equipping the advertising media device with a wireless receiver, such as a ZigBee receiver. ZigBee is an open-standard direct sequence spread spectrum (DSSS) technology that can be used in either point-to-point communications or in a mesh network. A firmware “stack” of commands is utilized to maintain an in-store network and automatically route traffic between one or more message originators and one or more destinations. ZigBee transmitters, receivers and coordinator hardware and firmware are commercially available from numerous vendors.

The RF system hardware (e.g., complex programmable logic device (CPLD), random access memory (RAM) and/or programmable integrated circuit (PIC) chips) may be used to execute specific ZigBee processes and transmit/receive instructions under varying conditions. The ZigBee instruction set, networking commands and transmit/receive chips may, for example, reside on hardware in the RF system (e.g., on a communication board in the Spider described below), which exchanges data from a retail environment to and from a remote server.

In certain embodiments, a remote server may send a message to the RF system, over an in-store ZigBee network that indicates that a key product display is present, and that a given advertising message is to be added to the playlist or featured exclusively. Similarly, the removal of a particular product display may be recorded by the remote server if a given RF tag ceases to be detected, which could result in a message being transmitted to the advertising media device to signal that the advertising message associated with the product display is to be discontinued or temporarily suspended.

In addition, one or more embodiments may include a stock shelf monitoring device for detecting low or out-of-stock conditions. A low stock or out-of-stock condition may, for example, be identified by transmitting a message over the ZigBee network. In certain embodiments, the presence of a particular signal or network message could also be received directly by an advertising media device to trigger the discontinuation of a given advertising message. Alternatively, a particular signal or network message could be relayed by the RF system to a remote server for processing against one or more additional conditions (e.g., the presence or absence of a similar display containing additional inventory). The signal or message may be subsequently relayed to the advertising media device via the in-store network to cause the media device to modify, discontinue or launch a new advertising message.

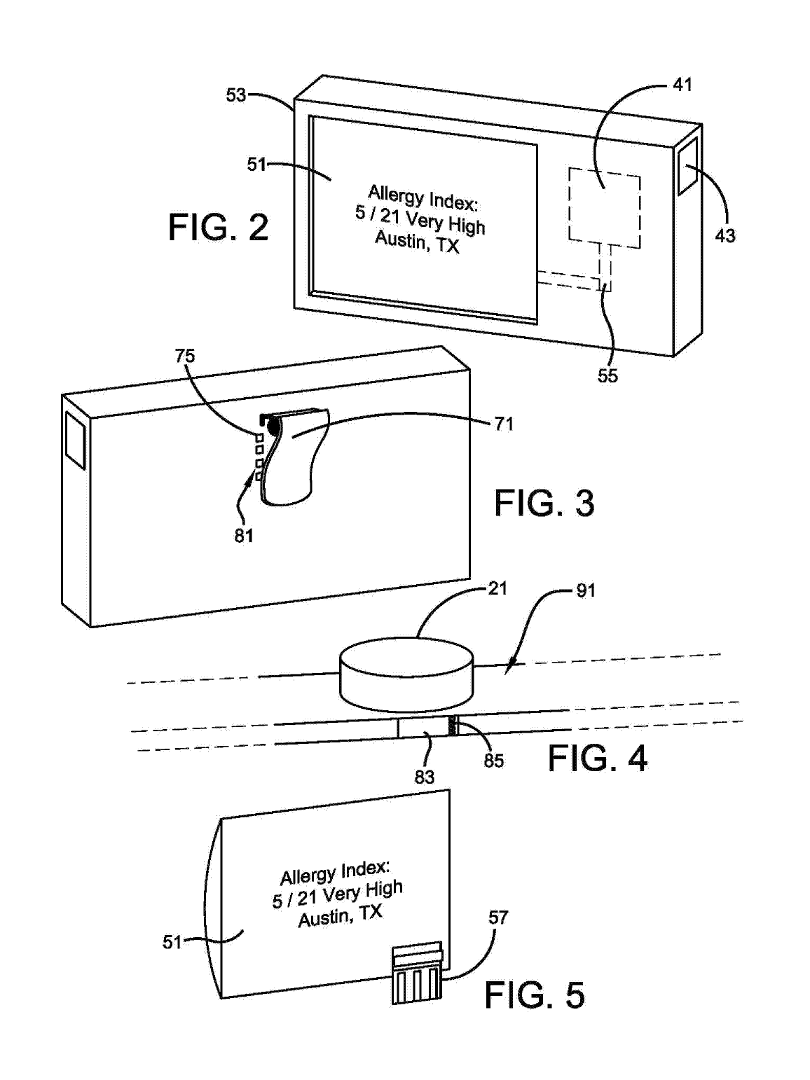

FIG. 12 depicts an example RF system that may be used with the retail advertising systems and methods described above with reference to FIGS. 7-10 and can additionally incorporate or substitute features of FIGS. 1-6 as well. The RF system may, for example, be used to detect and report the presence and location of radio frequency (RF) tags across selected zones in a retail environment. The RF system may also be used to centralize RF transmission and receiving functions to reduce the expense of recurring components.

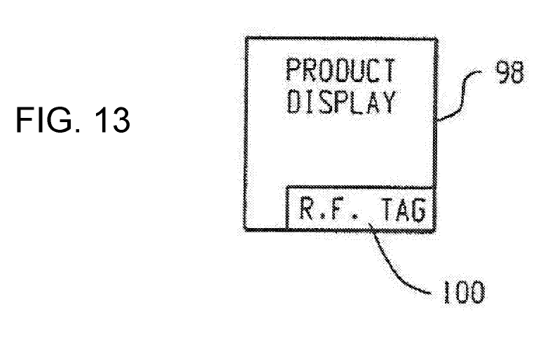

FIG. 13 depicts an example object 98 having an RF tag 100 associated therewith. The object may be a permanent display, Point of Purchase (POP) temporary display, signage, advertising material, stock-alert sensors, merchandising material, category section marker, individual product, or other material desired to be monitored by retailers, manufacturers, or point-of-sale producers (collectively referred to herein as a “display”). Even theaters promoting new films or current films with display and broadcast data would be a suitable environment. The object may also be a consumer (or movable object) to which an RF tag is associated so that the shopping (movement) pattern of the consumer can be monitored. In this manner, consumer exposure to a given display may be tracked. An RF tag given to a consumer may, for example, be a small active transmitter tag (ATT) that uses the same frequency and protocol as the reflection from the semi-passive tags.

This written description uses examples to disclose the invention, including the best mode, and also to enable a person skilled in the art to make and use the invention. The patentable scope of the invention may include other examples that occur to those skilled in the art. For instance, in one example the advertisement coordination system may determine from the RF system that one or more of the RF tags are not located at one or more predetermined locations in the retail environment, and in response cause an alert to be broadcast to store operations to place or remove a product display within a predetermined proximity of the advertising media device.

It is further noted that the systems and methods described herein may be implemented on various types of computer architectures, such as for example on a single general purpose computer or workstation, or on a networked system, or in a client-server configuration, or in an application service provider configuration.

It is further noted that the systems and methods may include data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, index information, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It is claimed:

1. A system comprising:
a gateway capable of transmitting and receiving index information in communication with a server;
an index controller with a unique ID configured to wirelessly receive the index information from the gateway;
an electronic display coupled to the index controller;
the index controller and electronic display is on or in the vicinity of a product or product display unit in a retail environment, the electronic display displaying the index information;
the index information being associated with a geographical location of the retail environment;
a storage device storing the index controller's unique ID associated with the product, the index information related to the product, and the geographical location of the index controller or the gateway that is in communication with the index controller;
a processor executing instructions configured to determine whether the index controller is on or in the vicinity of the product or product display unit.

2. A system comprising:
a gateway capable of transmitting and receiving index information in communication with a server;
an index controller with a unique ID configured to wirelessly receive the index information from the gateway; and
an index controller coupled to an electronic display;
the index controller and electronic display are in the vicinity of a product or product display unit in a retail environment that is associated with the index information, and the index information is displayed on the electronic display;
wherein whether the index controller is on or in the vicinity of the product or product display unit is determined by a wireless identification tag on the index controller and a wireless identification tag on the product or product display unit.

3. The system of claim 1, wherein the index information includes information relating to regional environmental forecasts relevant to the geographical location of the retail environment in which the index controller is physically located.

4. The system of claim 1, wherein the gateway receives updated index information at least once a day.

5. The system of claim 4, wherein the electronic display changes at least once a day based on the updated index information.

6. The system of claim 1, wherein the index controller comprises electrical contacts that interface with electrical contacts on the product display unit.

7. The system of claim 1, further comprising a product or product display unit comprising a wireless identification tag, and the index controller comprises a wireless identification tag, wherein only if the product or product shelf and the index controller are in the same vicinity, the index controller allows the index information to be displayed on the electronic display.

8. The system of claim 1, further comprising a repeater in communication with the gateway; wherein the index controller receives the index information from the gateway or repeater.

9. The system of claim 1, wherein the gateway is in communication with the server through a cellular network or the Internet

10. The system of claim 1, wherein the electronic display is an electrophoretic electronic paper display capable of using no power while displaying index information.

11. The system of claim 1, further comprising the server, and the server is located outside the retail environment.

12. The system of claim 1, wherein the index information is exclusive of price and product advertising information.

13. The system of claim 1, wherein the index information is exclusively regional environmental index information for the current day, and optionally date and location information.

14. The system of claim 1, wherein the geographical location of the retail environment is determined from a GPS signal associated with the gateway.

15. The system of claim 1, wherein the electronic display is attached to a product shelf that physically supports products on sale in a retail environment, the product shelf including an associated wireless identification tag; and the system further configured to detect a location of the wireless identification tag and thus a location of the product shelf in the retail environment.

16. The system of claim 2, wherein the system determines from the wireless identification tags that one or more of the wireless identification tags do not have the simultaneous presence in the same area in the retail environment, and in response causes an alert to be broadcast to place the index controller and the wireless identification tag simultaneously in the same area.

17. A method for providing environmental index information for display near relevant products in a retail environment comprising:
receiving index information at a gateway;
selectively awakening an index controller with an ID by a wireless signal based on a wireless identification tag on the index controller and optionally its proximity to a product or product display unit with a wireless identification tag;
communicating index information to the index controller when the index controller is on or in the vicinity of a product or product shelf that is associated with the index information; and
displaying the index information on an electronic display.

18. The method of claim 17, wherein the index controller's ID is associated with the product or product display unit and the index information is associated with and a geographical location of the retail environment.

19. The method of claim 17, further comprising detaching the index controller from the product or the product display unit and attaching it to another product or another product display unit; and
signaling the index controller to change the electronic display to display index information relevant to a product in the vicinity of the another product or the another display unit.

20. The method of claim 17, wherein the electronic display is an electrophoretic electronic paper display.
